(19) United States
(12) Patent Application Publication
(10) Pub. No.: US 2025/0277317 A1
(43) Pub. Date: Sep. 4, 2025

(54) SEAWATER ELECTROLYZER WITH OSMOTIC WATER SEPARATION

(71) Applicant: UNIVERSITY OF SOUTH CAROLINA, COLUMBIA, SC (US)

(72) Inventors: WILLIAM MUSTAIN, BLYTHEWOOD, SC (US); MOHAMMED AL MURISI, COLUMBIA, SC (US)

(21) Appl. No.: 18/658,133

(22) Filed: May 8, 2024

Related U.S. Application Data
(60) Provisional application No. 63/512,711, filed on Jul. 10, 2023.

(51) Int. Cl. C25B 9/21; C02F 1/44; C02F 103/08; C25B 1/04; C25B 13/02; C25B 15/08

(52) U.S. Cl. CPC C25B 9/21; C02F 1/445; C25B 1/04; C25B 13/02; C25B 15/085; C02F 2103/08

(57) ABSTRACT

Disclosed are electrolyzer systems and methods that combine forward osmosis with electrolysis to produce hydrogen from a water source such as seawater. The systems can operate with low energy input through immersion in the water source or by flowing the water source past osmotic membranes of a system to establish osmosis and simultaneous electrolysis.

### CROSS REFERENCE TO RELATED APPLICATION

This application claims filing benefit of U.S. Provisional Patent Application Ser. No. 63/512,711 having a filing date of Jul. 10, 2023, which is incorporated herein by reference for all purposes.

### FEDERAL RESEARCH STATEMENT

This invention was made with Government support under Award No. N00014-22-1-2742, awarded by the Office of Naval Research. The Government has certain rights in the invention.

### BACKGROUND

Renewable energy sources are increasingly supplementing or replacing fossil fuels. Hydrogen is an ideal renewable energy source as it is efficient, plentiful, and portable. It can be produced by electrolysis of water and easily stored and transported prior to use. As a fuel it can be reacted directly or indirectly with oxygen to produce water in an environmentally friendly energy production process. Environmentally friendly production of hydrogen can further improve the ecological benefits of this fuel source. Environmentally friendly production of hydrogen is also greatly beneficial toward reducing the carbon footprint of many industrial hydrogen applications including use in chemical production, food processing, and petroleum refining, among others.

To minimize the environmental impact, it is desirable to produce hydrogen from impure and readily available water sources, such as seawater, so as to limit undesirable effects on and overuse of clean water. Traditionally, seawater electrolysis is carried out by first pumping seawater to a location where the seawater is deionized, generally by a reverse osmosis process, and then electrolyzing the purified water by use of a traditional alkaline or polymer electrolyte membrane (PEM) electrolyzer. Unfortunately, this approach requires high energy consumption for both the deionization and electrolysis processes, and necessitates a relatively large footprint of operations.

What are needed in the art are systems and methods that can avoid traditional issues with seawater electrolysis. For instance, systems that can access the impure water at the source and that do not require water to be deionized externally before hydrogen production would be of great benefit. Such methods and systems can provide a lower energy use process, possibly zero-emission, that would be of great benefit to the art.

### SUMMARY

According to one embodiment, disclosed is an electrolyzer system that includes a first electrode, a second electrode, and a first aqueous electrolyte. The first aqueous electrolyte is in ionic communication with the first electrode, and the first electrode is in electrical communication with the second electrode. The electrolyzer also includes a first semi-permeable barrier, with a first side of the first semi-permeable barrier being configured for association with a water source that includes water and an impurity, e.g., seawater, and a second side of the first semi-permeable barrier being configured for association with the first aqueous electrolyte. The first aqueous electrolyte is at a higher osmotic pressure than the water source and as such, the first semi-permeable membrane can function as an osmosis membrane that selectively draws water from the water source into the first aqueous electrolyte.

Electrolyzers disclosed herein can also include a second aqueous electrolyte and a second semi-permeable barrier, with a first side of the second semi-permeable barrier being configured for association with the water source and a second side of the second semi-permeable barrier being configured for association with the second aqueous electrolyte. The second aqueous electrolyte can be in ionic communication with the second electrode and the second semi-permeable barrier can function as an osmosis membrane that can selectively draw water from the water source into the second electrolyte.

Also disclosed are methods for producing hydrogen. A method can include contacting a first side of a first semi-permeable barrier with a water source that includes one or more impurities in conjunction with water, e.g., seawater. The first semi-permeable barrier can be associated on a second side with a first aqueous electrolyte, and the first aqueous electrolyte can be at a higher osmotic pressure as compared to the water source. As such, upon contact, water can be selectively drawn by osmosis across the first semi-permeable barrier from the water source to the first aqueous electrolyte.

A method can also include establishing a voltage potential between first and second electrodes, with at least one of the electrodes being in ionic communication with the first aqueous electrolyte, thereby instigating electrolysis of the water to produce hydrogen at one of the electrodes. The hydrogen thus produced can then be collected.

Methods disclosed herein can also include contacting a first side of a second semi-permeable barrier with the water source. The second semi-permeable barrier can be associated on a second side with a second aqueous electrolyte, and the second aqueous electrolyte can be at a higher osmotic pressure as compared to the water source. As such, upon the contact, water can be selectively drawn by osmosis across the second semi-permeable barrier from the water source to the second aqueous electrolyte. In such an embodiment, the first aqueous electrolyte can be in ionic communication with the first electrode and the second aqueous electrolyte can be in ionic communication with the second electrode.

Other features and aspects of the present invention are set forth in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 schematically illustrates one embodiment of an electrolyzer system.

FIG. 2 schematically illustrates a top view of the system of FIG. 1.

FIG. 3 schematically illustrates another embodiment of an electrolyzer system.

FIG. 4 illustrates a top view of a cylindrical configuration for an electrolyzer system.

FIG. 5 schematically illustrates another embodiment of an electrolyzer system.

FIG. 6 schematically illustrates another embodiment of an electrolyzer system.

FIG. 7 schematically illustrates one embodiment of an electrolyzer as may be incorporated in a system as described herein.

FIG. 8 graphically illustrates osmotic flow across ion exchange membranes over a range of source water salt concentrations.

FIG. 9 graphically illustrates the voltage potential across an electrolysis cell over time at various applied currents.

FIG. 10 graphically illustrates the voltage potential across another electrolysis cell over time at various applied currents.

FIG. 11 graphically illustrates the voltage potential across another electrolysis cell over time at various applied currents.

FIG. 12 graphically illustrates the voltage potential across another electrolysis cell over time at an applied current.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present invention.

The present disclosure is directed to electrolyzer systems and methods that can produce hydrogen from a water source that contains impurities. In one particular embodiment, the systems can be designed for electrolysis of seawater, but disclosed systems are not limited to such, and disclosed systems can be used with other impurity-containing water sources, such as brackish water or municipal or agricultural wastewater. Beneficially, disclosed systems can operate with lower energy input as compared to previously known seawater electrolyzers and require little or no use of fresh or purified water. Disclosed systems can be relatively small and compact, and can be capable of producing hydrogen with little or no environmental impact at the system location.

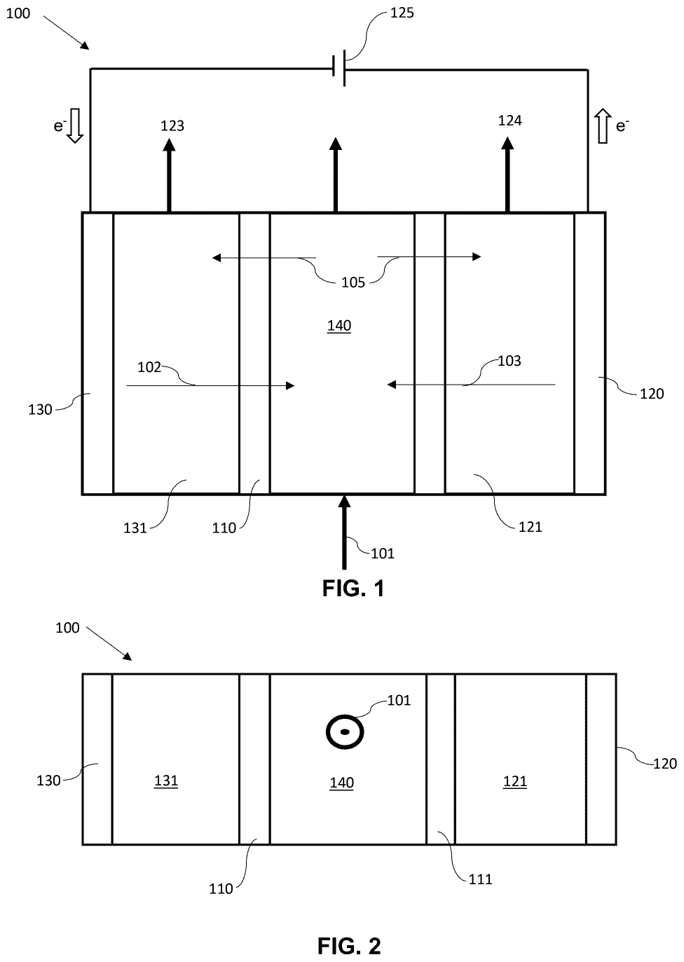

Disclosed systems incorporate a forward osmosis water purification process in conjunction with an electrolyzer. One embodiment of an electrolyzer system 100 is illustrated in FIG. 1 and FIG. 2, which illustrate a side view and a top view, respectively, of the system 100. In this embodiment, a system can include a cathode 130 and an anode 120 separated from one another by a water source flow-through 140 for feed water 101.

The cathode side of the electrolyzer system 100 can include a cathode electrolyte compartment 131 separated from the water source flow-through 140 by a first semi-permeable barrier 110 and the anode side of the electrolyzer system 100 can include an anode electrolyte compartment 121 separated from the water flow-through 140 by a second semi-permeable barrier 111.

The semi-permeable barrier 110 can allow ion migration 102, e.g., hydroxyl ion migration, from the cathode electrolyte compartment 131 to the water source flow-through 140, and the semi-permeable barrier 111 can allow ion migration 103, e.g., proton migration, from the anode electrolyte compartment 121 to the water source flow-through 140. In addition, both semi-permeable barriers 110, 111, can allow passive forward osmotic passage of water 105 while preventing passage of impurities, e.g., salts, that may be contained in the water source flow-through 140 into the respective electrolyte compartment 131, 121.

In one embodiment, the half reaction at the anode 120 will be as follows:

2H₂O→O₂+4H⁺+4e⁻

and the half reaction at the cathode 130 will be as follows:

4H₂O+4e⁻→2H₂+4OH⁻

However, the half reaction at each electrode is not limited to the above, and the particular half reaction can vary depending on the nature of each electrode, the composition of the electrolyte contacting each electrode, i.e., acidic or alkaline, etc., as is known in the art.

The semi-permeable barriers 110, 111 can be the same or different from one another and can in one embodiment include ion exchange membranes as are known in the art. By way of example, a semi-permeable barrier 110 can include an anion exchange polymer electrolyte membrane (PEM) or other suitable anion exchange membrane as is known in the art such as, and without limitation to, functionalized and quaternized poly(norbornenes) such as those sold by Xergy, Inc. under the trade name Xion™, poly(aryl piperidinium) based materials sold by Versogen™, anion exchange membranes sold by Ionomr™ under the trade name Aemion+™, polyaromate-based materials sold by Fumatech™ under the trade name Fumasep®, a polytetrafluoroethylene (PTFE) based membrane, such as a radiation-grafted polyethylene based materials (e.g., poly (ethylene-co-tetrafluoroethylene), chloromethylated polysulfones, etc.

A semi-permeable barrier 111 can include a proton exchange PEM or other proton exchange membrane as is known in the art. Examples of proton exchange membranes for a semi-permeable barrier 111 can include those available from The Chemours Company, Wilmington, Del., under the trade designation Nafion®, from Solvay, Brussels, Belgium, under the trade designation Aquivion®, proton exchange membranes sold by Ionomr™ under the trade name Pemion+™ perfluorinated materials sold by Fumatech™ under the trade name Fumapem®, and materials from Asahi Glass Co. Ltd., Tokyo, Japan, under the trade designation Flemion®. In embodiments, the membrane can include a PTFE-based material, such as a copolymer of tetrafluoroethylene and FSO₂—CF₂CF₂CF₂CF₂—O—CF═CF₂.

In some embodiments, one or both of the semi-permeable barriers 110, 111 can include functionality that can modify the osmotic and/or ionic flow characteristics across the membrane. For instance, in one embodiment, one or both of the semi-permeable barriers 110, 111 can be modified to include a selective barrier layer that imparts selective water osmosis across the barrier 110, 111. For instance, a PEM of a semi-permeable barrier 110 can include a selective barrier layer on a surface. Likewise, a PEM forming a semi-permeable barrier 111 can include a selective barrier layer that can be the same or different as compared to a selective barrier layer on semi-permeable barrier 110.

In general, a selective barrier layer may include a polymer. In certain embodiments, a selective barrier layer may include a polyamide, such as a polyamide urea, a block polyamide co-polymer or a polypiperazine. In certain embodiments, a polysulfone layer may be applied to a support layer. In certain embodiments, the selective barrier layer can include a semipermeable three-dimensional polymer network, such as an aliphatic or aromatic polyarnide, aromatic polyhydrazide, polybenzimidazolone, polyepiamine/amide, polyepiamine/urea, polyethyleneimine/urea, sulfonated polyfurane, polybenzimidazole, polypiperazine isophtalamide, a polyether, a polyether-urea, a polyester, a polyimide, a polytetrafluoroethylene (PTFE), or a copolymer or blend of one or more of the above. In certain embodiments, the selective barrier layer can include an aromatic or non-aromatic polyamide, such as residues of a phthaloyl (e.g., isophthaloyl or terephthaloyl) halide, a trimesyl halide, or any combination thereof. In one embodiment, a polyamide may include residues of diaminobenzene, triaminobenzene, polyetherimine, piperazine or poly-piperazine, or residues of a trimesoyl halide and/or residues of a diaminobenzene. The selective barrier layer can include residues of trimesoyl chloride and m-phenylenediamine. In one embodiment, the selective barrier layer can include the reaction product of trimesoyl chloride and m-phenylenediamine.

A selective barrier layer may be characterized by a thickness adequate to impart desired impurity rejection and water permeability properties while generally minimizing overall layer thickness. In certain embodiments, the selective barrier layer may have an average thickness of from about 50 nm to about 200 nm.

In an embodiment in which one or both of the semi-permeable barriers 110, 111 can include a selective barrier layer on a surface of an ion exchange membrane or a porous support layer, the semi-permeable barrier 110, 111, can generally be configured such that a side of the semi-permeable barrier that includes the selective barrier layer faces the water source flow through 140.

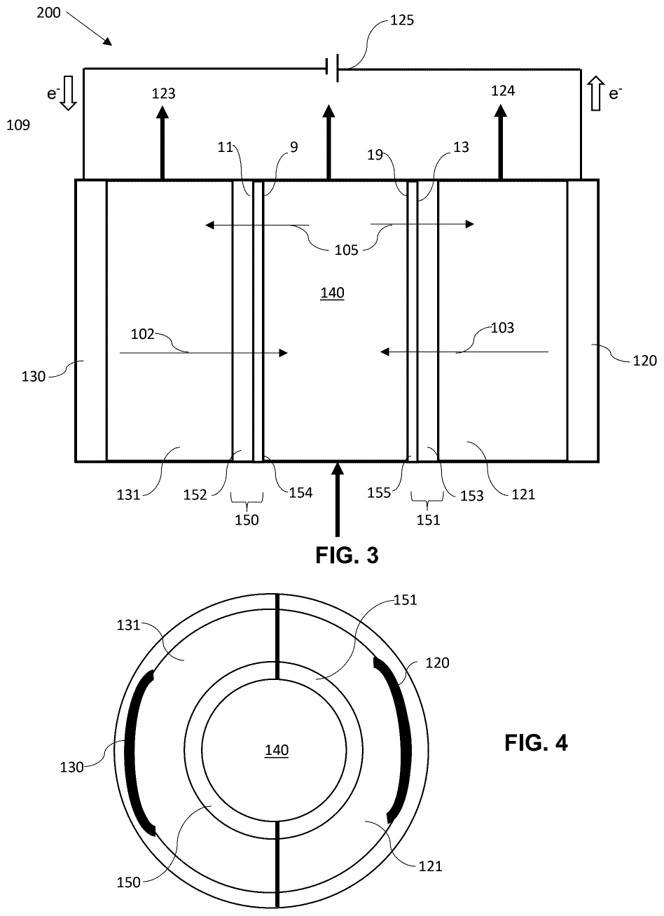

In one embodiment, one or both of the cathode electrolyte compartment 131 and the anode electrolyte compartment 121 can be separated from the water source flow-through 140 by a semi-permeable barrier that includes multiple membranes, each of which including one or multiple layers. For example, and as illustrated in FIG. 3, an electrolyzer system 200 can include a semi-permeable barrier 150 separating the cathode electrolyte compartment 131 from the water source flow-through 140 and can include a semi-permeable barrier 151 separating the anode electrolyte compartment 121 from the water source flow-through 140.

The semi-permeable barrier 150 can include an ion exchange PEM 152 in conjunction with a semi-permeable membrane 154, which can be in the form of a single layer or in one embodiment can be in the form of a thin-film composite membrane that includes a selective barrier layer on a porous support layer. The semi-permeable barrier 151 can include an ion exchange PEM 153 in conjunction with a semi-permeable membrane 155, which can be in the form of a thin-film composite membrane that includes a selective barrier layer on a porous support layer.

In such an embodiment, the semi-permeable membranes 154, 155 can be the same or different from one another. In addition the individual layers of a multi-layer semi-permeable barrier 150, 151 can be adhered to one another or retained in fluid contact with one another with little or no direct physical attachment therebetween, or some combination thereof in the case of multi-membrane barriers.

In one embodiment, a semi-permeable membrane 154, 155 can include a selective barrier layer as described above, optionally on the surface of a porous support layer. In one embodiment, a porous support layer for a selective barrier layer can also function as an ion exchange membrane. In another embodiment, a porous support layer can be a polymeric layer that doesn't necessarily provide selective ion exchange functionality. In either case, a selective barrier layer can be provided on a support layer according to any methodology. For instance, a selective barrier layer can be formed on the surface of a porous support layer via polymerization, for example, via interfacial polymerization. Alternatively, a selective barrier layer can be independently formed and then applied to a surface of a porous support layer, e.g., by use of a transfer layer.

Polymers that may be suitable for use in a porous support layer can include, without limitation, a polysulfone, a polyethersulfone, a poly(ether sulfone ketone), a poly(ether ethyl ketone), a poly(phthalazinone ether sulfone ketone), a polyacrylonitrile, a polypropylene, a poly(vinyl fluoride), a polyetherimide, a poly(norbornene), a polytetrafluoroethylene (PTFE), cellulose acetate, cellulose diacetate, cellulose triacetate polyacrylonitrile, or any combination thereof.

In general, a porous support layer may be characterized by a thickness adequate to provide support and structural stability to a semi-permeable membrane 154, 155 during manufacture and use while generally minimizing overall membrane thickness. In certain embodiments, a porous support layer may have an average thickness from about 10 μm to about 75 μm.

In some embodiments a semi-permeable membrane 154, 155 can include a first side (active side) 9, 19 that includes a selective barrier layer and that defines a first plurality of pores, and a second side (support side) 11, 13 that includes a support layer and that defines a second plurality of pores. In general, the first plurality of pores and the second plurality of pores can be fluidly connected to each other. In one embodiment, the average diameter of substantially all (e.g., 90% or more) of the first plurality of pores of the active side of the semi-permeable membrane can be between about 50 nm and about 500 nm, and the average diameter of substantially all of the second plurality of pores of the support side can be between about 5 μm and about 50 μm.

In some embodiments, a semi-permeable barrier can include one or more additives, which can be incorporated in a porous support layer or any other layer, as desired. An additive can provide any desirable benefit to the structure of function of a semi-permeable barrier. By way of example, an additive may add strength, fouling resistance, hydrophilicity, or other desirable properties to a semi-permeable barrier. For example, a semi-permeable barrier can include from about 0.1 wt. % to about 1 wt. % of a polyvinylpyrrolidone that can be added to a layer to enhance hydrophilicity in the structure.

A semi-permeable membrane 154, 155 can be located such that a first side 9, 19, i.e., the active side, of each membrane 154, 155 is configured for contact with water in the water source flow through 140, e.g., seawater. The second side 11, 13, i.e., the support side, of the membrane 154, 155 can face the respective ion exchange membrane 152, 153 of each semi-permeable barrier 150, 151.

Independent of the number of layers or membranes forming the semi-permeable barriers between the water source flow through 140 and the respective electrolyte compartments 131, 121, and to provide osmosis of water 105 from the water source flow through 140 to the respective electrolyte compartments 131, 121, the aqueous electrolytes of each compartment 131, 121 can be at a higher osmotic pressure than the water source within the water source flow through 140. This differential in osmotic pressure can be obtained through selection and control of the concentration of the ionic content of the aqueous electrolytes retained in the electrolyte compartments 131, 121. For instance, when considering utilization of seawater as a water source, the salt concentration of seawater being drawn through the water source flow through 140 can be lower than the concentration of the salts in the aqueous electrolytes in the electrolyte compartments 131, 121, ensuring the desired difference in osmotic pressure between the water source in the water source flow through 140 and the aqueous electrolytes in the electrolyte compartment 131, 121, and thereby to allow for water 105 to flow from the water source flow through 140 into the electrolyte compartments 131,121. Likewise, when considering other water sources, e.g., brackish water, wastewater, etc., a difference in salinity or other suitable impurity concentration in the water source can provide for a difference in osmotic pressure that can drive water osmosis 105 into the electrolyte compartments 131, 121. In general, the osmotic pressure of each of the cathode electrolyte compartment 131 and the anode electrolyte compartment 121 combined with the current density of the power supply 125 can be predetermined such that the rate of water flux into and ion flux across the associated semi-permeable barrier 110, 111, or multi-membrane barrier 150, 151 can match the rate of water electrolysis.

The electrolyte compartments 131, 121 can each retain an aqueous electrolyte, which can include any suitable alkaline or acidic electrolyte. For instance, the electrolyte compartments 131, 121 can retain the same type of electrolyte (i.e., both acidic or both alkaline), or different types of electrolytes (i.e., one acidic and one alkaline). Moreover, in those embodiments in which the electrolyte compartments 131, 121 retain the same type of electrolyte, the particular electrolyte composition and/or concentration within the electrolyte compartments 131, 121 can be the same or differ from one another.

In one embodiment, the aqueous electrolyte within one or both of the electrolyte compartments 131, 121 can include an alkaline electrolyte such as, and without limitation to, carbonates (e.g., HCO₃⁻/CO₃²⁻), sodium chloride, potassium chloride, sodium hydroxide, potassium hydroxide, sodium sulfide, potassium sulfide, etc., or any combination thereof. For example, an alkaline aqueous electrolyte can include an alkaline electrolyte, e.g., KOH, at a concentration of about 0.5 M or greater, such as from about 0.5 M to about 10 M.

In one embodiment, an alkaline aqueous electrolyte can have a pH of about 9 or greater, such as about 10 or greater, about 11 or greater, or about 12 or greater, such as from about 9 to about 15 or from about 12 to about 14.5 in some embodiments.

In one embodiment, the aqueous electrolyte within one or both of the electrolyte compartments 131, 121 can include an acidic aqueous electrolyte such as, and without limitation to, a mineral acid (e.g., a strong inorganic acid) such as phosphoric acid, hydrochloric acid, nitric acid, fluorosulfonic acid, or sulfuric acid, or a mixture thereof; or a strong organic acid such as acetic acid, formic acid, p-toluene sulfonic acid, or trifluoromethane sulfonic acid or mixtures thereof as well as mixtures of different types of acids, e.g., a combination of a mineral acid and an organic acid. For example, an acidic aqueous electrolyte retained in an anode electrolyte compartment 121 can include an acid electrolyte, e.g., H₂SO₄, at a concentration of about 0.5 M or greater, such as from about 0.5 M to about 10 M.

In one embodiment, an acidic aqueous electrolyte can have a pH of about 5 or less, such as about 4 or less, about 3 or less, about 2 or less, or about 1 or less, such as from about −1 to about 3 in some embodiments.

A preferred electrolyte type and concentration can depend on the characteristics of the water source, to ensure that the aqueous electrolyte can have a higher osmotic pressure than the water source, and thereby ensuring osmosis of water 105 from the water source flow through 140 to the cathode electrolyte compartment 131 across the semi-permeable barrier 110 or multi-membrane barrier 150 and to the anode electrolyte compartment 121 across the semi-permeable barrier 111 or multi-membrane barrier 151.

The anode 120 and cathode 130 can be formed of materials and associated with other electrolyzer components as are generally known in the art, and the active materials and structure of the electrodes 120, 130 are not particularly limited. For instance, the electrodes 120, 130 can include one or more active materials selected from Au, Ag, Pd, Pt, Ir, Rh, Cu, Fe, Ni, Co, Sn, Ti, In, Al, Ta, Sb, Ru, Mo and Cr. It will be understood that any electrode active materials as known in the art are encompassed herein including single active material electrodes and multiple active material electrodes either with or without a carrier material.

Preferred electrode active materials can generally depend upon the type of electrode (cathode or anode), as well as upon other characteristics of the electrolyzer, e.g., type and concentration of the aqueous electrolytes, expected current density, etc. In those embodiments in which one or both electrodes include two or more kinds of metals, the metals may be an alloy in the form of a solid solution, a eutectic crystal not in the form of solid solution, or a mixture of an alloy and a eutectic crystal.

Representative cathode active materials can include, without limitation, platinum (Pt), nickel on cerium oxide (Ni/CeO₂), lanthanum oxide on carbon (La₂O₃/C), nickel on iridium oxide (Ni/IrO₂), chromium-iron (Cr—Fe; e.g., stainless steel), nickel-molybdenum (Ni—Mo), platinum-nickel (Pt—Ni), platinum-cobalt (Pt—Co), platinum-copper (Pt—Cu), platinum-iron (Pt—Fe), platinum-palladium (Pt—Pd), nickel (Ni), platinum on titanium (Pt/Ti), nickel-cerium oxide-lanthanum oxide-carbon composites (Ni/(CeO₂—La₂O₃)/C), ruthenium (Ru), nickel iron cobalt (NiFeCo), nickel aluminum molybdenum (NiAlMo), etc., as well as combinations of active materials.

Representative anode active materials can include, without limitation, lead ruthenium oxides (Pb₂Ru₂Oₓ), chromium-iron (Cr—Fe; e.g., stainless steel), iridium oxides (IrO₂, IrOₓ), ruthenium oxide (RuO₂), copper cobalt oxides (CuCoOₓ, CuCoO₃) (optionally, on a carrier such as nickel foam), nickel-iron (NiFe), nickel-cobalt-iron (NiCoFe), NiCoOₓ on Fe, Ni, Cu_{0.7}CO_{2.3}O₄, Ce_{0.2}MnFe_{1.8}O₄, NiCo₂O₄ (optionally, on a carrier such as steel mesh), CuₓCo₃₋ₓO₄, NiFe₂O₄, NiAl, Pt, platinum-ruthenium (Pt—Ru), platinum iron (Pt—Fe), platinum nickel (Pt—Ni), platinum cobalt (Pt—Co), platinum molybdenum (Pt—Mo), Pt—Ru—Mo, Pt—Ru—Ni, etc., as well as combinations of metals.

Optionally, an electrode can include one or more additional materials that can improve one or more functions of the electrode. For instance, in some embodiments, an electrode can further include a binder and/or a polymeric material that can be utilized to modify/control a characteristic of the electrode, e.g., a mechanical characteristic such as strength, modulus, etc., and/or a physical characteristic such as hydrophilic/hydrophobic characteristics. Such binders and polymers can also be included in a separation membrane of a system, e.g., a PEM and/or a selective barrier membrane of a system. Binding polymers can include electrode/PEM binders as are generally known in the art, examples of which can include, without limitation, polytetrafluoroethylenes (PTFE), carboxymethylcellulose (CMC), rubbers such as styrene butadiene rubber (SBR) and natural latex rubbers, polyacrylic acids (PAA), polyurethanes, ethylene vinyl acetates, polyacrylamides, starches, etc. When present, a binding component can generally be present in component of the system in a relatively small amount, e.g., less than about 5 wt. % of an electrode.

As indicated, an electrolyzer system 100, 200 can include a power supply 125 in electrical connection with each electrode 120, 130.

The oxygen formed at the anode 120 can be discharged from the cell as at 124 and optionally collected and the hydrogen formed at the cathode 130 can be discharged from the cell as at 123 and collected or directly utilized. For instance, the hydrogen can be collected in pressurized tanks and stored/transported for later use.

A system can include additional modifications as desired to adjust flow across the semi-permeable barrier(s) such that the osmotic flow rate is sufficient to support the electrolysis rate at the electrodes and such that the ionic flow rates are substantially equivalent to the ion formation rates to ensure that the osmotic pressures within the electrolyte compartments remain stable. For example, an electrolyzer system can include a design to control surface area of osmotic and ionic transport, e.g., a rectangular design, a top view of which is illustrated in FIG. 2, or a cylindrical design, a top view of which is illustrated in FIG. 4, in which the water source flow-through 140 is in the form of a cylinder with the semi-permeable barriers 150, 151 each surrounding a portion of the central water source flow-through 140. The cathode and anode electrolyte compartments 131, 121 are thus in fluid communication with both the water source flow-through 140 and the respective electrodes 130, 120 via the semi-permeable barriers 150, 151 that can be shaped (e.g., with radial curvature) and sized (with sector distance and axial length) to a desired geometry to provide desired water and ion flow characteristics.

In another embodiment, the geometry and/or topology of a layer of a single membrane semi-permeable barrier, and/or a multi-membrane semi-permeable barrier of a system can be modified to adjust an osmotic and/or ionic flow rate between a water source flow-through 140 and an electrolyte compartment 121, 131. For instance, a single-layer selective barrier, or a layer of a multi-membrane selective barrier can include additional surface area through modification of the geometry, e.g., corrugation, protuberances, or other geometric modification, to modify the surface area of transport and thereby modify the osmotic and/or ionic flow rates to match the electrolysis rates at the electrodes. Likewise, a system can include baffles or other geometric modifications that can decrease the transport surface area. In one embodiment, a system can include a dynamic transport area modification system, e.g., dynamic baffles that can be relocated so as to increase or decrease the exposed surface area of a semi-permeable membrane that is available for transport.

To operate an electrolysis system 100, 200, a water source 101 (e.g., seawater) can be passively or actively caused to flow through the water source flow-through 140, upon which osmosis can transport water from the source through the semi-permeable barriers 110, 111 or multi-layer barriers 150, 151, and through the respective electrolyte compartments 131, 121 to the electrodes 130, 120. Upon establishing a voltage potential between the electrodes, electrolysis can occur producing hydrogen at the cathode 130 and oxygen at the anode 120. The system can include outlets 123, 124, via which hydrogen and oxygen can exit the system and be collected. As the rate of ion formation can be equal to the transport rate of ions out of the electrolyte compartments, the osmotic pressure of the electrolyte compartments can remain stable. In addition, as an equal number of protons and hydroxyl ions can be delivered to the water source flow-through 140 during operation, the bulk characteristics of the source water 101 will remain stable.

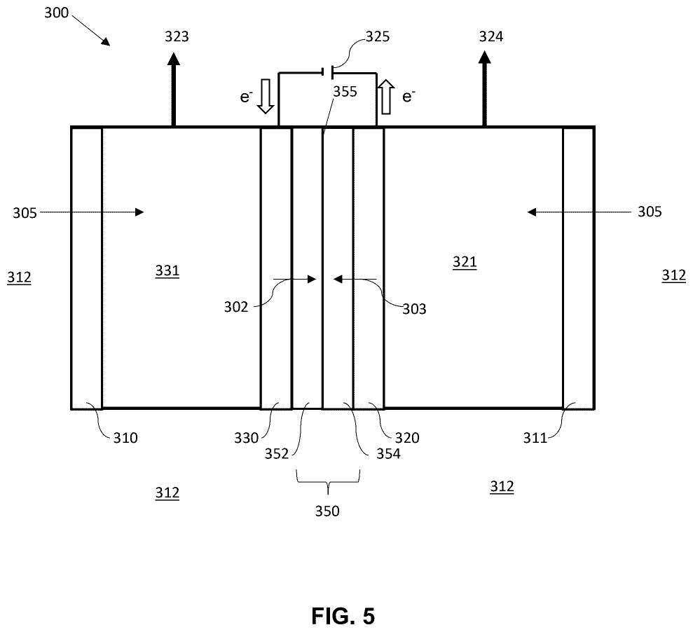

FIG. 5 illustrates another embodiment of an electrolyzer system 300. As indicated, in this embodiment, the system does not include a water source flow through within a central opening in the device. Instead, in this embodiment, the water source 312 can be retained external to the system 300, and this water source 312 can flow past the device or alternatively the device can simply be retained within a relatively still water source. For instance, in one embodiment, electrolyzer system 300 can be immersed in a water source 312 that can surround all or a portion of the electrolyzer system 300 and that can include a forced or natural flow past the system 300. Moreover, any flow past the system 300 can be periodic, constant, variable in flow rate, or any other combination of flow/non-flow characteristics.

The electrolyzer system 300 can include a semi-permeable barrier 310 separating the water source 312 from a cathode electrolyte compartment 331 and a semi-permeable barrier 311 separating the water source 312 from an anode electrolyte compartment 321. The semi-permeable barriers 310, 311 can be the same or different from one another and can include a single layer membrane, a multilayer membrane, a plurality of single layer or multilayer membranes, or any combination thereof. The semi-permeable barriers 310, 311 can allow passive osmotic passage of water 305 from the water source 312 into the respective electrolyte compartments 321, 331 while preventing passage of impurities into the electrolyte compartments. For example, the semi-permeable barriers 310, 311 can be in the form of a single thin-film composite membrane that includes a selective barrier layer on a porous support layer as previously described herein. In other embodiments, only a single membrane can be utilized as a semi-permeable barrier 310, 311, or one or more multi-layer membrane can be included, for instance to provide additional mechanical strength to the barriers 310, 311.

The cathode electrolyte compartment 331 can retain an aqueous electrolyte such as described previously. For example, an alkaline aqueous electrolyte retained in a cathode electrolyte compartment 131 can include an alkaline electrolyte, e.g., KOH, at a concentration of about 0.5 M or greater, such as from about 0.5 M to about 10 M.

The anode electrolyte compartment 321 can retain an aqueous electrolyte such as described previously. For example, an acidic aqueous electrolyte retained in an anode electrolyte compartment 321 can include an acid electrolyte, e.g., H₂SO₄, at a concentration of about 0.5 M or greater, such as from about 0.5 M to about 10 M.

In other embodiments, both electrolyte compartments can retain an alkaline aqueous electrolyte or both electrolyte compartments can retain an acidic aqueous electrolyte, which can be the same or different from each other. For example, cathode electrolyte compartment 331 and anode electrolyte compartment 321 can both retain an alkaline aqueous electrolyte, but they need not be identical to one another with regard to content or concentration.

The electrolyzer system 300 can also include a cathode 330 and an anode 320, examples of which are described previously. In this embodiment, the electrodes 330, 320 can be separated by a separator 350, which allows ion flow but prevents current flow. In one embodiment a separator 350 can include an anion exchange PEM 352 in combination with a proton exchange PEM 354. In another embodiment, a separator 350 can include an anion exchange membrane PEM 352 without a proton exchange PEM 354, and in yet another embodiment, a separator 350 can include proton exchange PEM 354 without an anion exchange PEM 352. Ion exchange membranes as known in the art, examples of which have been described previously, can be utilized in conjunction with one another or separately. In those embodiments in which the separator 350 includes multiple ion exchange membranes in conjunction with one another, the membranes can be held adjacent to one another in any suitable fashion e.g., adhered to one another or retained adjacent to one another with little or no physical attachment between the two at the interface 355.

In this embodiment, the half reaction at the anode 320 will be as follows:

2H₂O→O₂+4H⁺+4e⁻

and the half reaction at the cathode 330 will be as follows:

4H₂O+4e⁻→2H₂+4OH⁻

In an embodiment in which the separator 350 includes both an anion exchange PEM 352 and a proton exchange PEM 354, the anion exchange PEM 352 allows hydroxyl ion migration 302 from the cathode 330 to the interface 355, and the proton exchange PEM 354 allows proton migration 303 from the anode 320 to the interface 355. Alternatively, a separator 350 can include only an anion exchange PEM or only a proton exchange PEM. In any case, at the interface of two PEM or at one side of a single ion exchange PEM separator, the hydroxyl anions and protons can recombine to form water, which can generally be consumed during operation of the cell 300. As stated previously, in such an embodiment, the semi-permeable barriers can provide for selective water transport according to a forward osmosis flow, but need not exhibit selective ion transport.

To operate the electrolysis system 300, the system can be immersed in a water source 312, upon which osmosis can transport water 305 from the source through the semi-permeable barriers 310, 311, and through the respective electrolyte compartments 331, 321 to the electrodes 330, 320. Upon establishing a voltage potential between the electrodes via the power source 325, electrolysis can occur producing hydrogen at the cathode 330 and oxygen at the anode 320. The system can include outlets 323, 324, via which hydrogen and oxygen can exit the system and be collected.

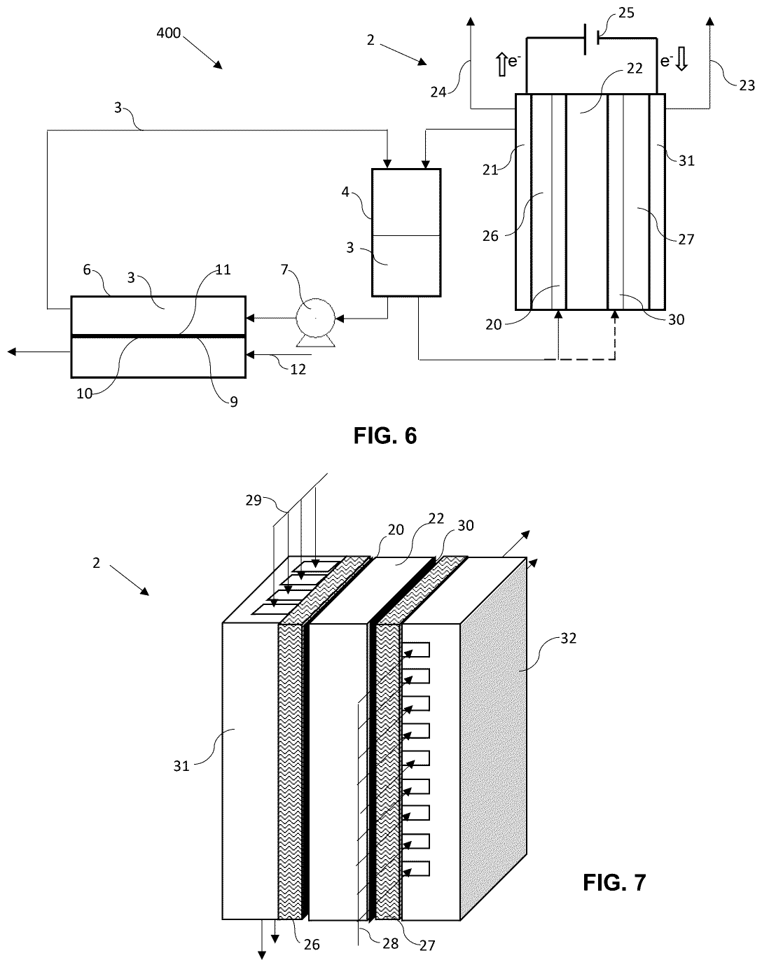

Another embodiment of an electrolyzer system 400 is illustrated in FIG. 6. In this embodiment, a system 400 can include electrolyzer 2, an aqueous electrolyte storage 4, and an osmosis module 6. The osmosis module 6 can include a semi-permeable barrier 10 that can allow water to pass from a water source 12 on a low osmotic pressure side of the membrane 10 to an aqueous electrolyte 3 on a high osmotic pressure side of the membrane 10.

In general, any semi-permeable barrier 10 can be utilized that allows passive osmotic passage of water while preventing passage of impurities, e.g., salts, that may be contained in a water source 12. A semi-permeable barrier 10 can typically be in the form of a thin-film or composite membrane that includes a single selective barrier layer or a selective barrier layer on an active side 9 of the semi-permeable barrier 10 and a porous support layer on a support side 11 of the semi-permeable barrier 10, examples of which are described above.

The osmosis module can be retained in the system 400 such that the semi-permeable barrier 10 can be configured for contact with an aqueous electrolyte 3. For instance, an aqueous electrolyte 3 can be conveyed by use of a pump 7 from the aqueous electrolyte storage 4 through the osmosis module 6 where it contacts the support side 11 of the semi-permeable barrier 10, and then back to storage 4.

As indicated in FIG. 6, the aqueous electrolyte 3 can be delivered to and utilized in an electrolyzer 2. For instance, the aqueous electrolyte 3 can be an alkaline aqueous electrolyte and the electrolyzer 2 can be an alkaline electrolyzer that includes an anode 20 and a cathode 30 separated by a PEM separator 22 and in electrical communication with one another and a power source 25 via current collectors 21, 31 associated with each respective electrode. A separator 22 can include an anion exchange PEM or a proton exchange PEM, examples of which are described elsewhere herein, or any other suitable separator 22 as is known in the art, e.g., a polysulfone separator that incorporates zirconium oxide as is available under the trade name Zirfon®.

In this embodiment, the half reaction at the anode 20 will be as follows:

4OH⁻→O₂+2H₂O+4e⁻

and the half reaction at the cathode 30 will be as follows:

4H₂O+4e⁻→2H₂+4OH⁻

As indicated in FIG. 6, an alkaline aqueous electrolyte 3 can be fed from a holding tank 4 to the electrolyzer 2 such that the electrolyte contacts the anode 20 and provides feed water to the electrolyzer 2. Optionally, the alkaline aqueous electrolyte 3 can be fed to the electrolyzer 2 such that it also contacts the cathode 30, however, and as indicated by the dashed delivery lines of FIG. 6, this is optional and alternatively, water can be provided to the cathode 30 only by water transport and recombination via the separator 22.

An electrolyzer system as disclosed herein can include other components as known in the art such as one or more gas diffusion layers, inlet and outlet flow channels, etc. For example and as illustrated in FIG. 7, an electrolyzer 2 can include porous layers 26, 27 adjacent to one or both of the electrodes 20, 30 that can improve flow and contact of the various materials. For instance porous layers 26, 27 can include gas diffusion layers that can facilitate removal of gaseous hydrogen and oxygen products from the electrodes. Gas diffusion layers of porous layers 26, 27 can be fibrous, particulate, or combinations thereof.

Porous layers 26, 27 can include a porous transport layer designed to improve delivery of an aqueous electrolyte to the electrodes 20, 30 as well as to remove the gaseous/liquid product flows from the electrodes 20, 30. In certain embodiments, a porous layer 26, 27 can be formed of sintered metal powders or fibers, metal mesh, or metal foams that can exhibit desirable porosity for fluid flow as well as electron transport capability. The particular metal of choice can depend upon the particular application of the porous transport layer, e.g., anodic or cathodic transport. Non-limiting examples of metals for use in forming a porous transport layer can include, without limitation, titanium, nickel, carbon, stainless steel, copper, etc.

Porous layers 26, 27 can optionally include multiple sub-layers of different porosities, e.g., microporosity, mesoporosity, and/or microporosity, in any desired combination to further refine and define the flow fields of the fluids at the electrode 20, 30 and encourage desired interactions between the electrode active materials and the reactants and products of the half-reactions.

An electrolyzer system can also define flow fields adjacent to one or both of the electrodes that can deliver and/or remove reactants and/or products to/from the system. For instance, in the illustrated embodiment of FIG. 7, the flow fields 28, 29, can be defined by channels formed in bipolar plates 31, 32, respectively. Bipolar plates 31, 32, can be of any design and formation as is generally known in the art so as to provide the desired flow fields 28, 29 generally in conjunction with one or more of electrical connections, temperature control through heat removal, and the like.

It will be understood that while FIG. 1-FIG. 7 illustrate single electrolyzer cells of a system, electrolyzer systems as described can include multiple cells. Accordingly, disclosed systems can be designed to produce large quantities of hydrogen from a water source in an environmentally friendly fashion.

The present invention may be better understood by reference to the Examples, set forth below.

### Example 1

An electrolyzer system similar to that illustrated in FIG. 1 was built. The ion exchange membranes included a composite PENTION™/XION™ anion exchange PEM available from Xergy, Inc. and a Nafion® proton exchange membrane available from DuPont Chemicals. The outer electrolyte compartments each had a volume of about 42 mL. The center compartment had a volume of about 60 mL.

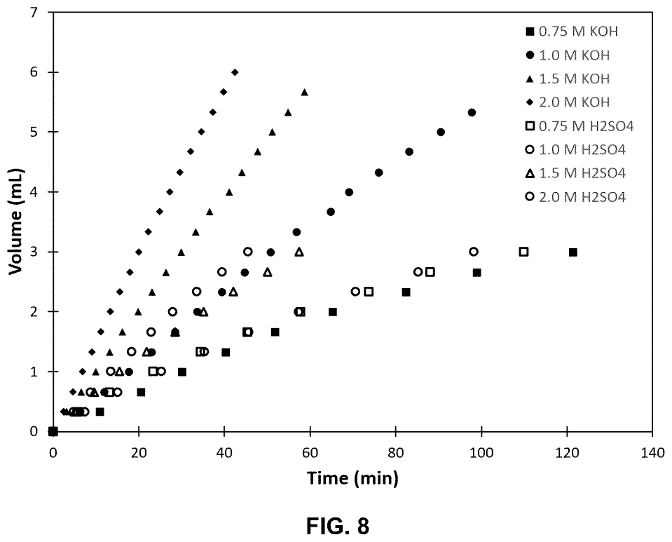

Initially, the rate of osmotic flow across the ion exchange membranes was examined with no electrodes integrated into the system. The alkaline electrolyte utilized was potassium hydroxide, the acidic electrolyte was sulfuric acid, and the water source was a 0.5 M sodium chloride solution. The aqueous electrolyte solutions were at the same concentrations in the anode and cathode electrolyte compartments. Various electrolyte concentrations were examined. Results are shown in Table 1 below and in FIG. 8. The rates indicated are measurement of the water flux across the membrane into the outer chambers containing KOH or H₂SO₄.

TABLE 1

| | | Initial | Initial | Initial |
|---|---|---|---|---|
| Electrolyte | | rate | Rate | Rate |
| Concentrations | Compartment | (mL/min) | (L/m²hr) | (mol_{H2O}/s) |
| 0.75M | H₂SO₄ | 0.058 | 2.891 | 5.33E−05 |
| | KOH | 0.030 | 1.520 | 2.82E−05 |
| 1.0M | H₂SO₄ | 0.045 | 2.273 | 4.19E−05 |
| | KOH | 0.052 | 2.636 | 4.86E−05 |
| 1.5M | H₂SO₄ | 0.065 | 3.260 | 6.01E−05 |
| | KOH | 0.104 | 5.207 | 9.60E−05 |
| 2.0M | H₂SO₄ | 0.070 | 3.526 | 6.50E−05 |
| | KOH | 0.140 | 7.052 | 1.30E−04 |

### Example 2

A cell as illustrated in FIG. 1 and described in Example 1 was assembled including a stainless steel cathode and a stainless steel anode. The water source solution was 0.5 M NaCl, the aqueous acidic electrolyte was 0.75 M H₂SO₄, and the alkaline electrolyte was 0.75 M KOH.

Various currents as shown in Table 2, below, were applied to the cell that had concentrations of the alkaline and acidic electrolytes of 0.6M. Table 2 also shows the volume change in the cathode and anode electrolyte compartments.

TABLE 2

| Current Applied | Volume rise in cathode | Volume rise in anode |
|---|---|---|
| (mA) | compartment (mL) | compartment (mL) |
| 10 | 0.59 | 0.66 |
| 100 | 0.33 | 0.36 |
| 200 | 0.0 | 0.0 |
| 300 | −0.13 | −0.13 |

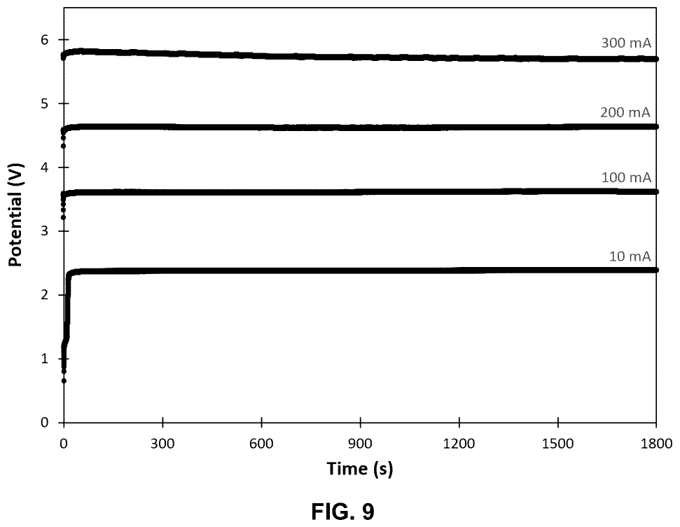

FIG. 9 presents the voltage potential over time for each operating condition in Table 2. The system successfully demonstrated that the rate of osmosis was equal to the rate of electrolysis but at lower than expected current due to ion co-diffusion. The stainless steel anode exhibited corrosion, particularly at higher currents, which suppressed the oxygen evolution reaction. The stainless steel cathode exhibited no visible change.

### Example 3

A cell as illustrated in FIG. 1 and described in Example 1 was assembled including coiled platinum electrodes. The water source solution was 0.5 M NaCl, the aqueous acidic electrolyte was 0.75 M H₂SO₄, and the alkaline electrolyte was 0.75 M KOH.

Various currents were applied as shown in Table 3, below, which also shows the volume change in the cathode and anode electrolyte compartments.

TABLE 3

| Current Applied | Volume rise in cathode | Volume rise in anode |
|---|---|---|
| (mA) | compartment (mL) | compartment (mL) |
| 10 | 0.5 | 0.3 |
| 100 | 0.5 | 0.2 |
| 200 | 0.5 | 0.0 |
| 300 | 0.2 | −0.3 |

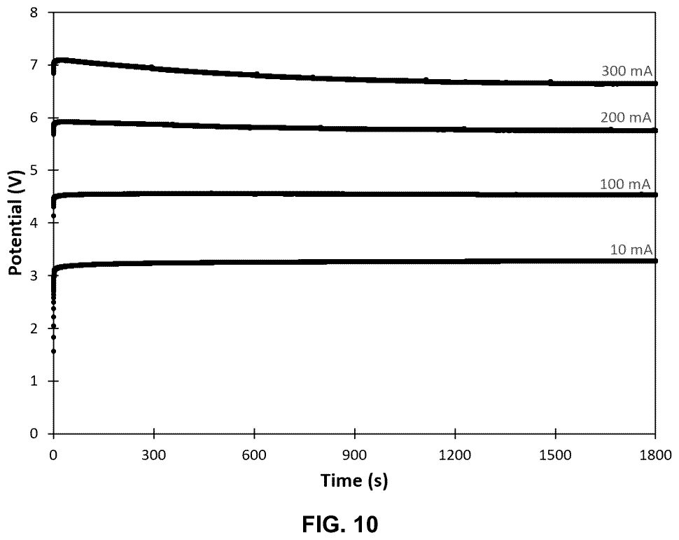

FIG. 10 presents the voltage potential over time for each operating condition in Table 3. The volume rise in the compartments was consistent with the system including the stainless steel electrodes in Example 2, and the osmosis-electrolysis rates matched well at 200 mA. No corrosion was observed on the electrodes and product visibly formed at both electrodes.

### Example 4

A cell as illustrated in FIG. 1 and described in Example 1 was assembled including a stainless steel anode and an IrO₂/Ni fiber cathode. The water source solution was 0.5 M NaCl, the aqueous acidic electrolyte was 0.75 M H₂SO₄, and the alkaline electrolyte was 0.75 M KOH.

Various currents were applied as shown in Table 4, below, which also shows the volume change in the cathode and anode electrolyte compartments.

TABLE 4

| Current Applied | Volume rise in cathode | Volume rise in anode |
|---|---|---|
| (mA) | compartment (mL) | compartment (mL) |
| 10 | 0.73 | 0.79 |
| 100 | 0.59 | 0.46 |
| 200 | 0.2 | 0.4 |
| 300 | −0.07 | −0.13 |

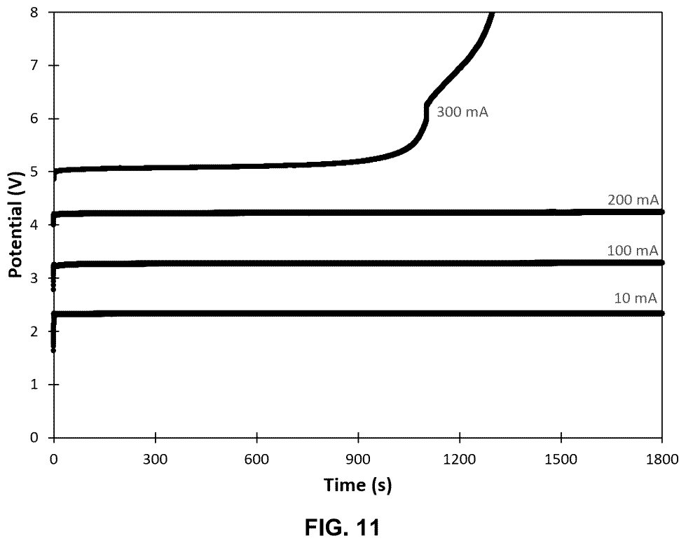

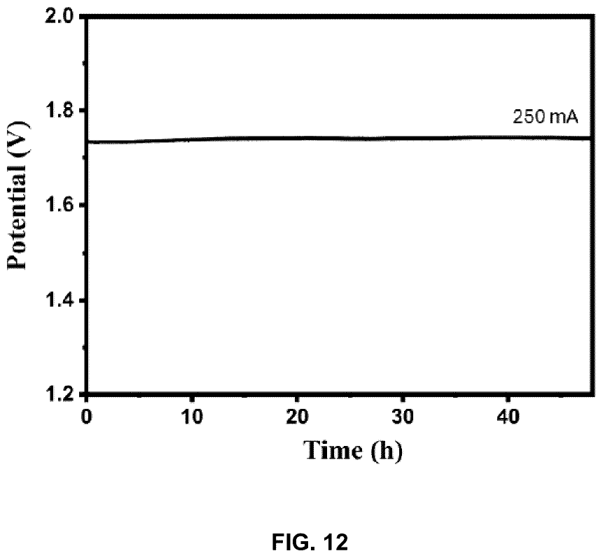

FIG. 11 presents the voltage potential over time for each operating condition shown in Table 4. As indicated, the operating voltage was reduced in this example. Additionally, there was some nickel corrosion at the higher currents/voltages.

### Example 5

A cell as illustrated in FIG. 5 was assembled. The anode was formed of IrOₓ on Ni fiber felt and the cathode was PtNi/C on a carbon paper (Toray™ 060). The anode and cathode were separated from one another by a quaternized poly(norbornene) anion exchange membrane. Both electrolyte compartments contained approximately 20 mL each 1.0 M KOH and each was separated from the source water by a semi-permeable porous PTFE selective membrane. The source water solution was 0.5M NaCl from a 500 mL reservoir.

A current of 250 mA was applied to the system. FIG. 11 presents the voltage potential over time. The system successfully demonstrated electrolysis and hydrogen formation.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. An electrolyzer system comprising:
a first electrode;
a second electrode in electronic communication with the first electrode;
a first aqueous electrolyte in ionic communication with the first electrode;
a first semi-permeable barrier including a first side configured for association with a water source comprising water and an impurity and a second side configured for association with the first aqueous electrolyte; wherein
the first aqueous electrolyte has a higher osmotic pressure than the water source and wherein upon the association of the first aqueous electrolyte, the water source and the first semi-permeable barrier, water is selectively drawn by osmosis from the water source to the first aqueous electrolyte.

2. The electrolyzer system of claim 1, wherein the water source comprises seawater.

3. The electrolyzer system of claim 1, further comprising a second aqueous electrolyte in ionic communication with the second electrode.

4. The electrolyzer system of claim 3, wherein the first and second aqueous electrolytes are both alkaline aqueous electrolytes, are both acidic aqueous electrolytes, or wherein one of the first and second aqueous electrolytes is an alkaline aqueous electrolyte and the other is an acidic aqueous electrolyte.

5. The electrolyzer system of claim 3, further comprising a second semi-permeable barrier, the second semi-permeable barrier including a first side configured for association with the water source and a second side configured for association with the second aqueous electrolyte, wherein the second aqueous electrolyte has a higher osmotic pressure than the water source and wherein upon the association of the second aqueous electrolyte, the water source and the second semi-permeable barrier, water is selectively drawn by osmosis from the water source to the second aqueous electrolyte.

6. The electrolyzer system of claim 1, the first semi-permeable barrier comprising an ion exchange polymer electrolyte membrane.

7. The electrolyzer system of claim 1, further comprising a water source flow-through.

8. The electrolyzer system of claim 1, the first semi-permeable barrier comprising a composite membrane that includes a selective barrier layer and a porous support layer.

9. The electrolyzer system of claim 1, the first semi-permeable barrier comprising a selective barrier layer and an ion exchange membrane.

10. The electrolyzer system of claim 1, further comprising an ion exchange polymer electrolyte membrane separating the first electrode and the second electrode.

11. A method for producing hydrogen, comprising:
contacting a first side of a first semi-permeable barrier with a water source at a first osmotic pressure, the water source comprising water and an impurity;
contacting a second side of the first semi-permeable barrier with a first aqueous electrolyte at a second osmotic pressure that is higher than the first osmotic pressure such that upon the contact, water is selectively drawn by osmosis from the water source to the first aqueous electrolyte;
establishing a voltage potential between a first electrode and a second electrode, the first electrode being in ionic communication with the first aqueous electrolyte, thereby instigating electrolysis of the water and forming hydrogen at the first or the second electrode; and
collecting the hydrogen.

12. The method of claim 11, further comprising:
contacting a first side of a second semi-permeable barrier with the water source; and
contacting a second side of the second semi-permeable barrier with a second aqueous electrolyte at a third osmotic pressure that is higher than the first osmotic pressure such that upon the contact, water is selectively drawn by osmosis from the water source to the second aqueous electrolyte.

13. The method of claim 12, wherein the first and second aqueous electrolytes are both alkaline aqueous electrolytes, are both acidic aqueous electrolytes, or wherein one of the first and second aqueous electrolytes is an alkaline aqueous electrolyte and the other is an acidic aqueous electrolyte.

14. The method of claim 13, wherein the aqueous alkaline electrolyte has a pH of about 9 or greater and/or the aqueous acid electrolyte has a pH of about 5 or less.

15. The method of claim 11, wherein the water source comprises seawater.

16. The method of claim 11, wherein the first side of the first semi-permeable barrier is contacted with the water source by flowing the water source past the first semi-permeable barrier.

17. The method of claim 11, wherein the first side of the first semi-permeable barrier is contacted with the water source by immersing the first semi-permeable barrier in the water source.

18. The method of claim 11, wherein the electrolysis forms protons and hydroxyl ions, wherein upon the electrolysis, at least one of the protons and the hydroxyl ions are transported across an ion exchange polymer electrolyte membrane.

19. The method of claim 18, wherein upon the electrolysis, the protons are transported through a proton exchange polymer electrolyte membrane and the hydroxyl ions are transported through an ion exchange polymer electrolyte.

20. The method of claim 18, wherein the first electrode and the second electrode are separated by a separator that includes the ion exchange polymer electrolyte membrane.
